(19) United States
(12) Patent Application Publication
(10) Pub. No.: US 2010/0247901 A1
(43) Pub. Date: Sep. 30, 2010

(54) LIGHT GUIDING PLATE

(76) Inventor: Cheng-Yang HSIEH, Taichung (TW)

Correspondence Address: Muncy, Geissler, Olds & Lowe, PLLC, 4000 Legato Road, Suite 310, FAIRFAX, VA, 22033, US

(21) Appl. No.: 12/415,748

(22) Filed: Mar. 31, 2009

(51) Int. Cl. B32B 5/16

(52) U.S. Cl. 428/328; 428/323

(57) ABSTRACT

A light guiding plate includes a substrate made of thermoplastic, and a plurality of optically reflecting particles evenly distributed in the substrate and having an average particle size ranging from 0.1 μm to 100 μm. Each reflecting particle has a shell made of a metal oxide such as Al₂O₃, ZnO or ZrO₂, and a core made of SiO₂, TiO₂, or the same material of the shell. Thus, the light guiding plate has a high light transmittance and can diffuse incident light evenly so that it can be used to substitute a conventional light guiding plate and diffuser combination.

### BACKGROUND OF THE INVENTION

1. Field of the Invention

The present invention relates to light guiding technology and more particularly, to a light guiding plate that has a high light transmittance and is capable of diffusing incident light evenly.

2. Description of the Related Art

A backlight module for LCD display generally comprises a light source, a light guiding plate, a reflector, a diffuser, a prism sheet and a polarizing film. The light guiding plate is adapted for guiding the direction of incident light, enhancing the luminance of the backlight module. The reflector is adapted for avoiding leakage of light through the bottom side of the light guiding plate, enhancing the luminance efficiency of incident light. The diffuser is adapted for diff-using outgoing light from the light guiding plate to form an even surface light source.

A conventional light guiding plate is a smooth plate member molded from polymethyl methacrylate (PMMA) through an injection molding process, having circular or rectangular diffusing spots of high reflectivity material printed on the bottom side thereof by means of screen-printing technique. When a light source is provided at one lateral side of the light guiding plate, these diffusing spots reflect incident light upwards toward the top side of the light guiding plate. However, the light that goes through the top side of the light guiding plate is not evenly distributed. Therefore, a diffuser must be used to diffuse light that comes out of the light guiding plate, thereby forming an even surface light source.

Because light guiding plate and diffuser are important elements of a backlight module that determine the luminous efficiency, manufacturers in this field are trying hard to make possible improvements.

### SUMMARY OF THE INVENTION

The present invention has been accomplished under the circumstances in view. It is the main object of the present invention to provide a light guiding plate, which has a high light transmittance and capable of diffusing incident light evenly.

To achieve this and other objects of the present invention, a light guiding plate comprises a substrate made of thermoplastic, and a plurality of optically reflecting particles evenly distributed in the substrate. The optically reflecting particles have an average particle size ranging from 0.1 μm to 100 μm. Each optically reflecting particle has a core and a shell. The shell is made of Al₂O₃, B₂O₃, BaCO₃, Bi₂O₃, CaCO₃, CeO₂, Cr₂O₃, CoO, Co₃O₄, CuO, Dy₂O₃, Er₂O₃, Eu₂O₃, Fe₂O₃, Ga₂O₃, Ge₂O₃, Gd₂O₃, HfO₂, Ho₂O₃, In₂O₃, K₂O₃, La₂O₃, Li₂CO₃, MgO, MgCO₃, Mn₂O₃, Mn₃O₄, MoO₃, Nb₂O₅, Nd₂O₃, NiO, PbO, Pb₃O₄, Pr₆O₁₁, Sb₂O₃, SiO₂, Sm₂O₃, SnO₂, SrCO₃, Ta₂O₅, Tb₄O₇, TeO₂, WO₃, V₂O₅, Y₂O₃, Yb₂O₃, ZnO or ZrO₂.

### BRIEF DESCRIPTION OF THE DRAWINGS

FIG. 1 is a schematic drawing showing the structure of a light guiding plate in accordance with the present invention.

### DETAILED DESCRIPTION OF THE INVENTION

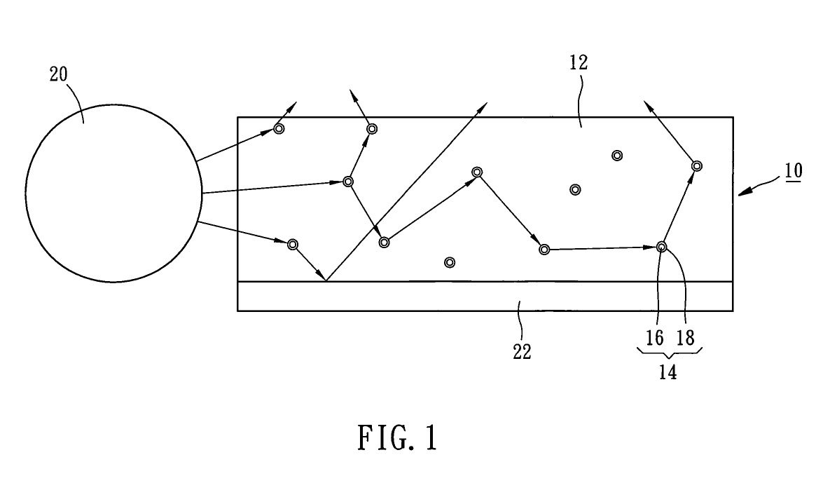

Referring to FIG. 1, a light guiding plate 10 in accordance with the present invention is shown comprising a substrate 12 and a plurality of optically reflecting particles 14.

The substrate 12 is molded from thermoplastic, such as methyl methacrylate resin, polyvinyl chloride or polystyrene. The methyl methacrylate resin can be polymethyl methacrylate, polyethyl methacrylate, polypropyl methacrylate, polybutyl methacrylate or polypentyl methacrylate.

The optically reflecting particles 14 are spherical particles evenly distributed in the substrate 12. According to HORIBA LB-500 dynamic light scattering submicron particle size distribution analyzer, the optically reflecting particles 14 have an average particle size ranging from 3 μm to 5 μm. Each optically reflecting particle 14 has a core 16 and a shell 18. The core 16 is made of SiO₂. The shell 18 is made of Al₂O₃, having an average wall thickness about 1.5 μm˜2.5 μm. The total weight of the optically reflecting particles 14 is about 1% of the weight of the light guiding plate 10.

During fabrication of the light guiding plate 10, well-ground optically reflecting particles 14 are evenly distributed in methyl methacrylate oligomer, and then the mixture thus prepared is shaped through a casting process, enabling methyl methacrylate to be polymerized farther into polymethyl methacrylate (PMMA) under appropriate temperature. The desired light guiding plate 10 having optically reflecting particles 14 embedded in the substrate 12 thereof is thus obtained.

Since the light guiding plate 10 has optically reflecting particles 14 embedded therein, the incident light coming from one lateral side or bottom side of the light guiding plate 10, reflected by the optically reflecting particles 14 toward different directions such that the top surface of the light guiding plate 10 forms an even surface light source. Thus, the light guiding plate 10 has a light-diffusion function. If the light source, referenced by 20, is provided at one lateral side of the light guiding plate 10, a reflector 22 can be provided at the bottom side of the light guiding plate 10 to avoid leakage of light through the bottom side of the light guiding plate 10, as shown in FIG. 1. Further, because the optically reflecting particles 14 have a very small particle size, the optically reflecting particles 14 hardly affect the light transmittance of the light guiding plate 10. There is no any difference between the light guiding plate 10 and a pure PMMA plate can be seen with the bare eyes. Therefore, the light guiding plate of the present invention can be used to substitute for a conventional light guiding plate and diffuser combination, avoiding light loss between light guiding plate and diffuser and improving luminance and evenness degree.

Based on the spirit of the present invention, the composition of the substrate and the composition and size of the optically reflecting particles may be varied. Subject to tests, the average particle size of the optically reflecting particles can be set within 0.1 μm˜100 μm, or preferably within 1 μm˜10 μm; the average wall thickness of the shell of the optically reflecting particles can be set within 0.05 μm˜50 μm. Further, the shell can be made of any of other metal oxides, such as B₂O₃, BaCO₃, Bi₂O₃, CaCO₃, CeO₂, Cr₂O₃, CoO, Co₃O₄, CuO, Dy₂O₃, Er₂O₃, Eu₂O₃, Fe₂O₃, Ga₂O₃, Ge₂O₃, Gd₂O₃, HfO₂, Ho₂O₃, In₂O₃, K₂O₃, La₂O₃, Li₂CO₃, MgO, MgCO₃, Mn₂O₃, Mn₃O₄, MoO₃, Nb₂O₅, Nd₂O₃, NiO, PbO, Pb₃O₄, Pr₆O₁₁, Sb₂O₃, SiO₂, Sm₂O₃, SnO₂, SrCO₃, Ta₂O₅, Tb₄O₇, TeO₂, WO₃, V₂O₅, Y₂O₃, Yb₂O₃, ZnO or ZrO₂. Further, the core can be made of SiO₂, TiO₂, or the same material of the shell. Further, the weight of the optically reflecting particles can be 0.1˜20% of the weight of the light guiding plate.

The foregoing description of the preferred embodiment of the present invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art.

What is claimed is:

1. A light guiding plate, comprising:
a substrate made of thermoplastic; and
a plurality of optically reflecting particles distributed in said substrate, said optically reflecting particles having an average particle size ranging from 0.1 μm to 100 μm, each said optically reflecting particle having a core and a shell, said shell being made of material selected from a group consisting of Al₂O₃, B₂O₃, BaCO₃, Bi₂O₃, CaCO₃, CeO₂, Cr₂O₃, CoO, Co₃O₄, CuO, Dy₂O₃, Er₂O₃, Eu₂O₃, Fe₂O₃, Ga₂O₃, Ge₂O₃, Gd₂O₃, HfO₂, Ho₂O₃, In₂O₃, K₂O₃, La₂O₃, Li₂CO₃, MgO, MgCO₃, Mn₂O₃, Mn₃O₄, MoO₃, Nb₂O₅, Nd₂O₃, NiO, PbO, Pb₃O₄, Pr₆O₁₁, Sb₂O₃, SiO₂, Sm₂O₃, SnO₂, SrCO₃, Ta₂O₅, Tb₄O₇, TeO₂, WO₃, V₂O₅, Y₂O₃, Yb₂O₃, ZnO and ZrO₂.

2. The light guiding plate as claimed in claim 1, wherein said core is made of material selected from a group consisting of SiO₂ and TiO₂.

3. The light guiding plate as claimed in claim 2, wherein said shell has an average wall thickness ranging from 0.05 μm to 50 μm.

4. The light guiding plate as claimed in claim 1, wherein said core and said shell are made of the same material.

5. The light guiding plate as claimed in claim 1, wherein said optically reflecting particles have an average particle size ranging from 1 μm to 10 μm.

6. The light guiding plate as claimed in claim 1, wherein said optically reflecting particles have an average particle size ranging from 3 μm to 5 μm.

7. The light guiding plate as claimed in claim 1, wherein the weight of said optically reflecting particles is 0.1˜20% of the weight of said light guiding plate.

8. The light guiding plate as claimed in claim 1, wherein said optically reflecting particles have a substantially spherical shape.
